(19) United States
(12) Patent Application Publication
(10) Pub. No.: US 2015/0243162 A1
(43) Pub. Date: Aug. 27, 2015

(54) PATIENT COMMUNICATION SYSTEM FOR A HEALTH CARE FACILITY WITH DISPOSABLE COMPONENT

(71) Applicants: David Daum, Lancaster, NY (US); James Engler, Depew, NY (US)

(72) Inventors: David Daum, Lancaster, NY (US); James Engler, Depew, NY (US)

(21) Appl. No.: 14/188,215

(22) Filed: Feb. 24, 2014

(51) Int. Cl. G08C 19/00

(52) U.S. Cl. CPC G08C 19/00; G08C 2200/00

(57) ABSTRACT

A communication system for a health care facility, having a translator unit operably arranged to communicate electronically with a device to be controlled and a pendant control located spatially separate and remote from the translator unit, the pendant control operably arranged to communicate electronically with the translator unit.

### REFERENCE TO COMPUTER PROGRAM LISTING APPENDIX

The present application includes the following computer program listing appendix. The computer program listing appendix is expressly incorporated herein by reference in its entirety. The appendix includes ASCII text files of the computer program as follows: translator_source_code.txt 46 KB Created Feb. 4, 2014 handset_source_code.txt 18 KB Created Feb. 4, 2014

### FIELD OF INVENTION

The present invention relates generally to a patient communication system for use in a health care facility. More specifically, the present invention relates to a universal patient communication system having a disposable pendant control.

### BACKGROUND OF THE INVENTION

Patient communication systems in health care facilities typically include a pendant control and a central call station (also known in the industry as a “patient station”) which are frequently used to control the electronic devices located in individual rooms as well as to communicate with a nurses' station. An example of a typical patient communication system of a health care facility is shown in FIGS. 1 through 3. In FIG. 1, typical pendant control 10 is shown held by patient 20 who is resting in bed 14. Pendant control 10 is powered by television 11 and hard-wired to central call station 15. Call station 15 is hard-wired to the various electronic devices in the room, including television 11, lights 12, and a nurses' station (not illustrated). Pendant control 10 comprises plurality of buttons 23 that controls the various electronic devices in the room including the various functions of television 11, such as changing the channel, adjusting the volume, controlling the lights 12, or calling for a nurse.

A partially exploded view of typical prior art pendant control 10, depicting some of the typical components within pendant control 10, is shown in FIG. 2. Pendant control 10 includes housing 30, first housing portion 31, second housing portion 32, speaker 21, plurality of speaker perforations 22, and plurality of buttons 23. Patients can hear the audio component of television 11 without disturbing others through speaker 21. Conventional pendant control 10 is often referred to as a pillow speaker because of the incorporated built-in speaker 21.

FIG. 3 is a rear view of first housing 31 of pendant control 10 shown in FIG. 2; herein, housing portion 31 depicts the internal components within pendant control 10. The internal components of pendant control 10 include plurality of electrical components 40. Plurality of electrical components 40 are mounted to circuit boards 50 and 51. The components include interface integrated circuit (IC) 42. Although not specifically labeled on the drawing, the components also include a television interface, power management circuitry, call circuit hardware, light control hardware, and interface specific hardware. It should be appreciated that conventional pendant control 10 contains expensive electrical components and accordingly, conventional pendant controls are designed as permanent room fixtures in health care facilities. As a result, pendant controls are not replaced until they malfunction or a new model or brand is introduced as a substitute. Typically, many differences and unique features exist between various manufacturers and combinations of these systems when used with aftermarket or add-on features. Accordingly, custom pendants are designed to work exclusively with the particular configurations of the facility. Custom pendants are costly and require longer lead times due to the work associated with manufacturing and assembly.

The frequent handling of pendant controls by a large number of patients creates an environment conducive to the growth of bacteria and viruses. To control the growth of bacteria and viruses it is common to wipe the pendant control with a disinfectant after each patient use. Although the top surface of the pendant control can be cleaned easily, the perforations of the speaker are difficult to clean. Contaminants on the top surface of the pendant control can be wiped into the perforations of the speaker and, once the bacteria and viruses are within the perforations, they are difficult to remove. In addition, case seams and gaps between the case and buttons are two other primary areas that retain contaminants and are similarly difficult to sanitize and clean. Subsequent patients are therefore exposed to the bacteria and viruses left behind.

The fact that pendant controls are expensive and difficult to service has been recognized. For example, U.S. Pat. No. 8,254,137 (Wilkolaski et al.) discloses a pendant control having an inexpensive and replaceable switch membrane overlay. By implementing an inexpensive and replaceable overlay, the pendant control can be used for a longer period of time. However, the replaceable overlay is arranged within the housing of the pendant control, which still leaves patients susceptible to bacteria located on the outside of the housing and within the perforations of the speaker.

In addition to being expensive and difficult to clean, conventional pendant controls are only compatible with a single television manufacturer. Since conventional pendant controls are not interchangeable among a variety of television manufacturers, and considering the relative high cost of pendant controls, it is no surprise that health care facilities have a very limited number of types of televisions available for patient use. U.S. Pat. No. 7,142,256 (Stoner et al.) discloses a programmable pendant control that interfaces with most televisions. However, the '256 patent does not disclose a pendant control that interfaces with different types of call stations.

Therefore, there has been a long-felt need for a patient communication system that is interchangeable with a plurality of televisions and nurse call systems found in health care facilities, including, but not limited to hospitals, nursing homes, clinics, and out-patient offices. Furthermore, there is a long-felt need for a pendant control that is easily cleaned. There is also a need for a pendant control that has the bare minimum of electrical components within the pendant control.

### BRIEF SUMMARY OF THE INVENTION

The invention is a communication system for a health care facility having a translator unit operably arranged to communicate electronically with a device to be controlled and a pendant control located spatially separate and remote from the translator unit. The pendant control is operably arranged to communicate electronically with the translator unit.

The invention is a translator unit for communicating with a device to be controlled having a housing electrically connected to a call station, interface specific hardware electrically connected to a pendant control, and a translation integrated circuit operatively arranged to communicate with the pendant control and the device to be controlled.

The invention is a pendant control for communicating with a translator unit consisting of a housing connected to the translator unit where the housing is located spatially separate and remote from the translator unit, a plurality of electrical switches operatively arranged to control an electrical device, and an interface integrated circuit operatively arranged to send and receive a plurality of signals from the translator unit.

A general object of the invention is to provide a health care facility patient communication system that is capable of functioning with any newly installed or existing call station.

Another object of the invention is to provide a pendant control that can operate a plurality of electronic devices connected to the call station in a health care facility.

A further object of the invention is to provide a pendant control that minimizes opportunities for the growth of bacteria and viruses.

Yet another object of the invention is to provide a pendant control that is less expensive than prior art controls.

Another object of the invention is to provide a pendant control that is disposable.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying figures, in which:

FIG. 1 is a perspective view of a typical health care facility patient room including a typical prior art patient communication system;

FIG. 2 is a partially exploded view of a typical prior art pendant control, exploded to show some of the typical components within pendant control 10;

FIG. 3 is a rear top view of housing portion 31 of the pendant control shown in FIG. 2, herein, housing portion 31 depicts the internal components within pendant control 10;

FIG. 4 is a perspective view similar to that shown in FIG. 1, except with the patient communication system of the present invention;

FIG. 5 is a partially exploded view of the pendant control of the present invention, exploded to show some of the typical components within pendant control 100;

FIG. 6 is a rear top view of housing portion 131 of the pendant control shown in FIG. 5; herein, housing portion 131 depicts the internal components within pendant control 100;

FIG. 7A is a block diagram illustrating a typical prior art patient communication system;

FIG. 7B is a block diagram illustrating a patient communication system of the present invention;

FIG. 8 is a block diagram of the electrical circuit of pendant control 100 of the present invention;

FIG. 9 is a schematic of entertainment control buttons 123 shown in FIG. 8;

FIG. 10 is a schematic of microcontroller circuit 140 shown in FIG. 8;

FIG. 11A is a schematic of the optional electrostatic discharge (ESD) Suppression unit 141 shown in FIG. 8;

FIG. 11B is a schematic of 24-pin connector 142 shown in FIG. 8;

FIG. 12 is a schematic of left speaker 121L, nurse call function 145, auxiliary functions 149, programming connector 133, local_interlock 195, optional indicator light emitting diodes (LEDs) 106, headphone jack 108, and optional battery 109 as shown in FIG. 8;

FIG. 13A is a schematic of optional backlight light emitting diodes (LEDs);

FIG. 13B is a schematic of optional vibration feedback motor;

FIG. 14 is a block diagram of the electrical circuit of translator unit 13 of the present invention;

FIG. 15 is a schematic of microcontroller 200 shown in FIG. 14;

FIG. 16A is a schematic of optional electrostatic discharge (ESD) Suppression unit 206 shown in FIG. 14;

FIG. 16B is a schematic of the 24-pin connector 142 shown in FIG. 14;

FIG. 17 is a schematic of 20-pin connector 201 shown in FIG. 14;

FIG. 18 is a schematic of power management circuitry 151, television data output circuitry 204, programming connector 205, and optional ambient light level sensor 208 shown in FIG. 14;

FIG. 19 is a schematic of serial control pull-ups 211 and power input 212 (television 233 or optional batteries 234) shown in FIG. 14;

FIG. 20 is a block diagram of the electrical circuit of programmer unit 300 of the current invention; and,

FIG. 21 is a schematic of 37-pin wall interface connector 400.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. The present invention is intended to include various modifications and equivalent arrangements within the spirit and scope of the appended claims. For example, the pendant control of the present invention may take many different forms and shapes, and control different appliances, devices and functions without departing from the spirit and scope of the invention as claimed.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

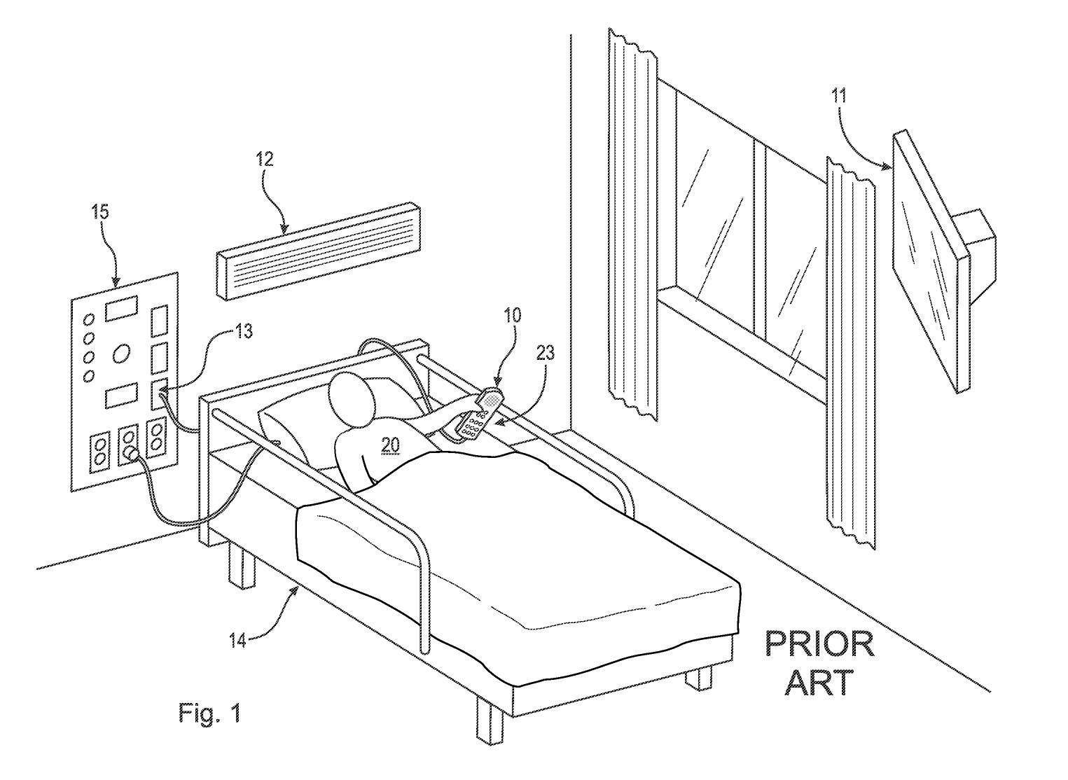

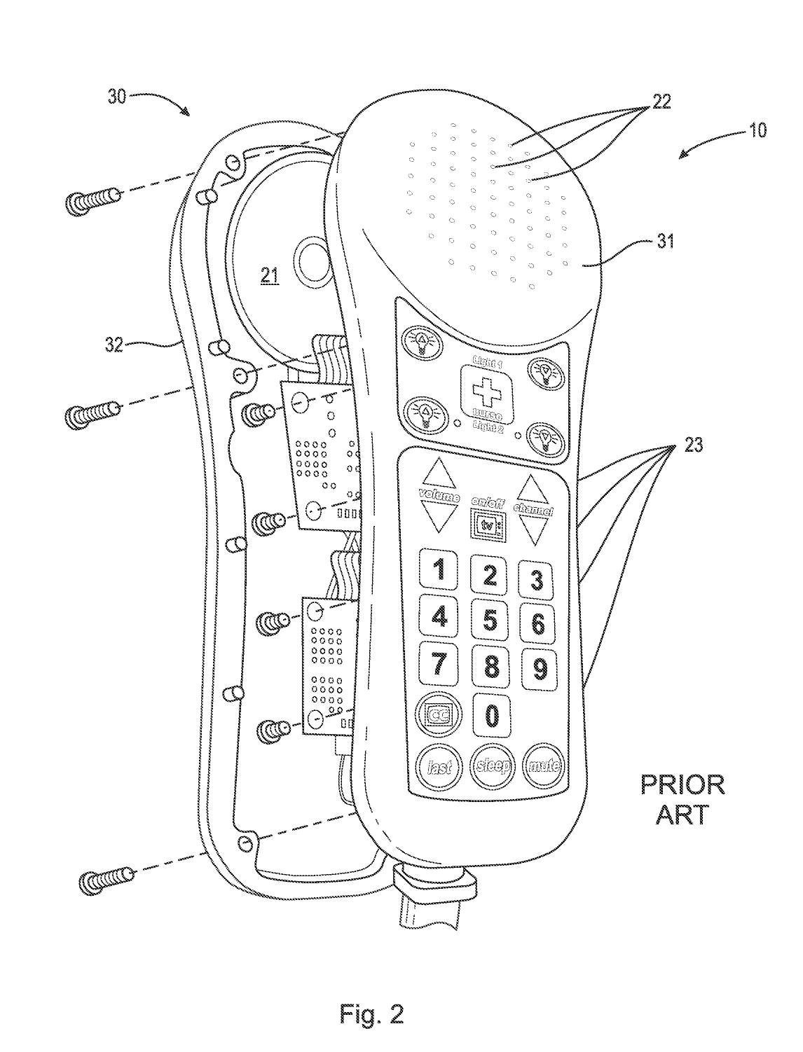

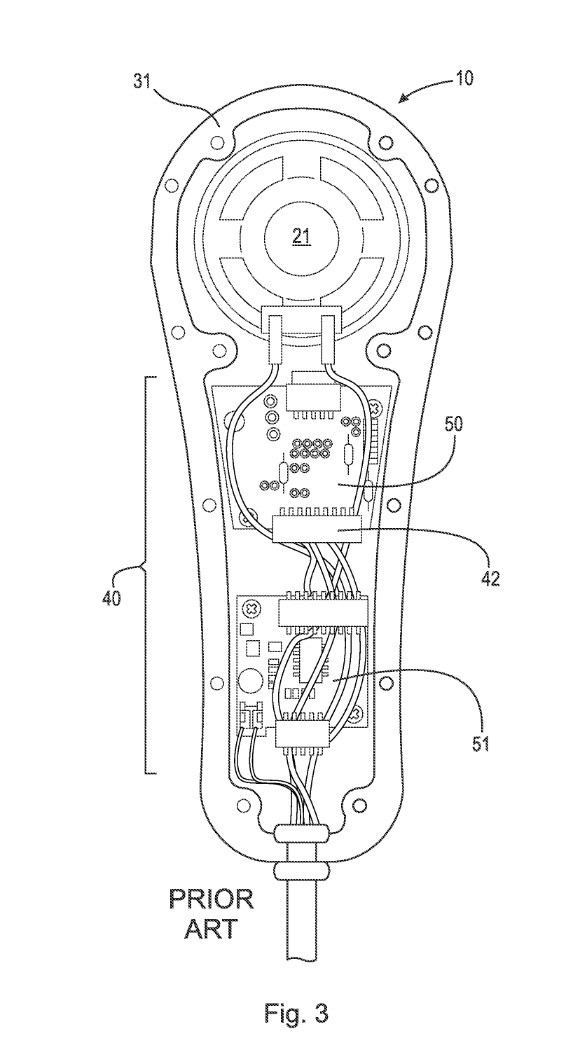

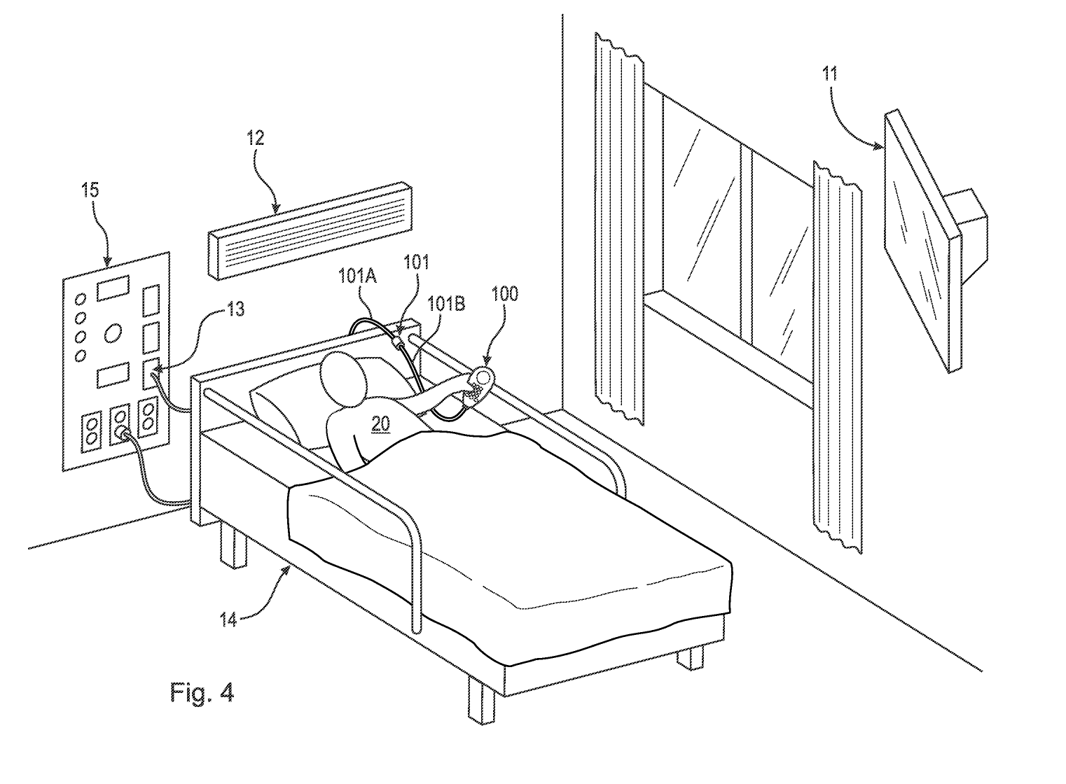

Adverting again to the Figures, FIG. 4 is a perspective view similar to that shown in FIG. 1, except the patient communication system of the present invention is shown instead. Patient 20 is shown resting in bed 14 holding pendant control 100. Pendant control quick disconnect cable 101A is hard-wired to translator unit quick disconnect cable 101B through quick disconnect connector 101. Translator unit 13 communicates with call station 15. Call station 15 is hard-wired to the various electronic devices in the room, including television 11, lights 12, and a remote nurses' station (not shown). Pendant control 100 allows patient 20 to operate the electronic devices in the room, including the various functions of television 11 (such as changing channels or adjusting volume), controlling lights 12, and calling for a nurse.

Translator unit 13 is spatially separate and remote from pendant control 100 in every patient room and communicates with at least one call station 15. It should be appreciated that translator unit 13 is programmable and can interface with any newly installed or prior existing call station 15 or television 11. It should be further appreciated that pendant control 100, when connected to translator unit 13, can operate any electronic devices/appliances in the room, regardless of model or manufacturer.

Quick disconnect connector 101 allows pendant control 100 to be easily disconnected and disposed of after use, and a new pendant control 100 to be connected when a new patient occupies the room. It should be appreciated that pendant control 100 can be easily disconnected and is thus transportable to any area of the building, regardless of the brand or manufacturer of call station 15.

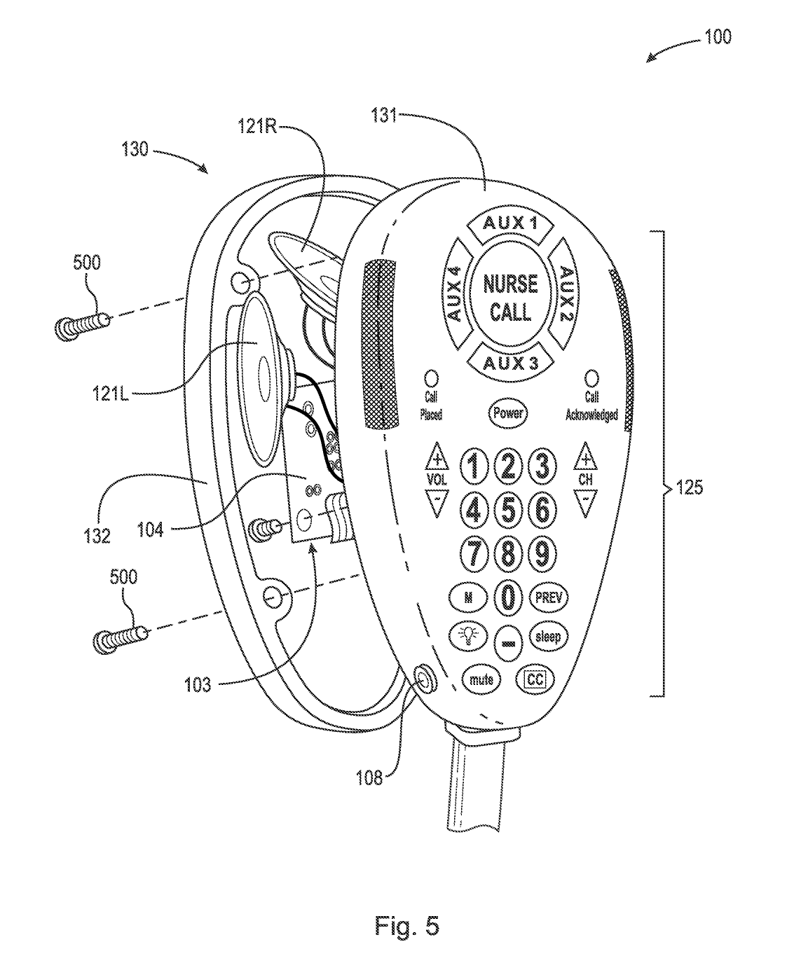

FIG. 5 is a partially exploded view of pendant control 100 of the present invention, exploded to show some of the typical components within pendant control 100. Speakers 121L and 121R, plurality of switches 103, and interface integrated circuit 104 are shown suspended between housing portion 131 and housing portion 132. In a preferred embodiment, pendant control 100 is disposable because, in the present invention, the relatively expensive electrical components typically found in a pendant control have been moved to translator unit 13. Pendant control 100 comprises housing 130, plurality of buttons 125, left speaker 121L, and right speaker 121R. Plurality of buttons 125 enables patient 20 to operate the electrical devices in the room, including the various functions of television 11 (such as changing channels or adjusting volume), lights 12, and nurse call. Housing 130 comprises housing portions 131 and 132, which are secured by any suitable fastening means, for example, screws 500. However, it should be appreciated that any suitable fastening means can be implemented. Speakers 121L and 121R enable patient 20 to listen to television 11 without disturbing others because the audio of television 11 can be transmitted through pendant control 100 rather than through television 11 across the room. In an example embodiment, either speaker 121L or 121R can also serve as a microphone enabling patient 20 to communicate with nurses' station (not shown). Housing portion 131 also includes headphone jack 108.

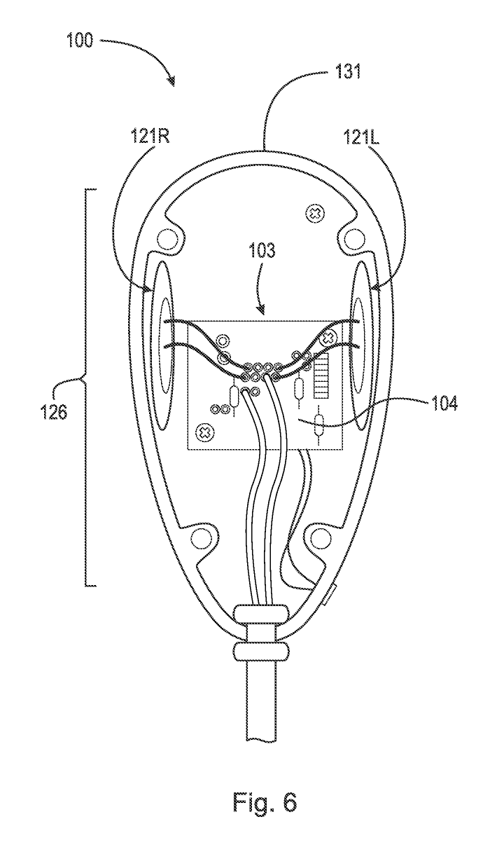

FIG. 6 is a rear top view of pendant control 100 shown in FIG. 5; herein, housing portion 131 depicts the internal components within pendant control 100. The internal components of pendant control 100 comprise left speaker 121L, right speaker 121R, and plurality of electrical components 126. Plurality of electrical components 126 further comprises plurality of switches 103 and interface integrated circuit 104. In an example embodiment, pendant control 100 operates on 3 volts.

In another embodiment, pendant control 100 further comprises optional electrostatic discharge (ESD) suppression circuitry 141, optional call indicator light emitting diodes (LEDs) 106, optional battery 109, optional backlight 110, optional vibration motor 111 and optional finder 112 (depicted in subsequent figures). ESD suppression circuitry 141 is provided to ensure a robust connection in a dry, static-filled environment.

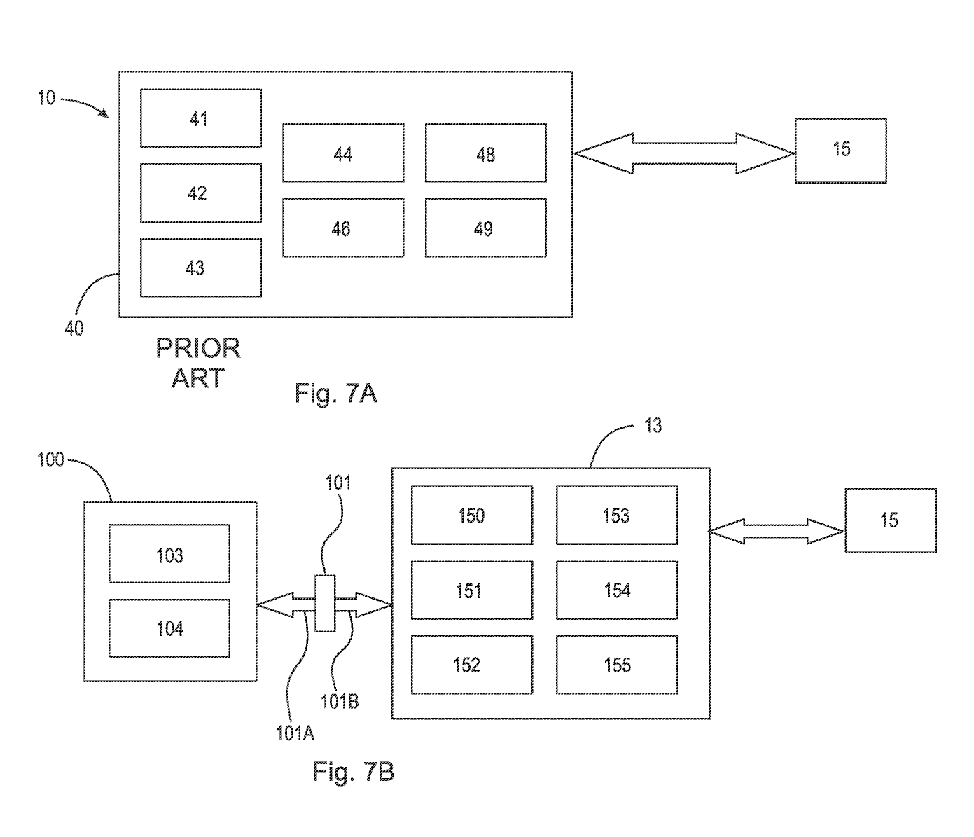

FIG. 7A is a block diagram illustrating the typical communication system. Pendant control 10 includes a plurality of electrical components 40, of which many of the electrical components are relatively expensive. Plurality of electrical components 40 includes switches 41, interface integrated circuit 42, power management circuitry 43, television interface 44, call circuit hardware 46, light control hardware 48 and interface specific hardware 49. Pendant control 10 is hard-wired to call station 15.

FIG. 7B is a block diagram depicting pendant control 100, translator unit 13, and call station 15. Pendant control 100 includes only plurality of switches 103 and interface integrated circuit 104 (hereinafter microcontroller circuit 140), in a preferred embodiment. It should be appreciated that pendant control 100 contains only the bare minimum components necessary to operate the electrical devices in the room and accordingly is less expensive to manufacture than pendant control 10. It should further be appreciated that due to the relatively low cost of producing pendant control 100, it can be disposed of after a single use. Pendant control 100 and translator unit 13 are connected by quick disconnect cables 101A and 101B, which are connected by quick disconnect connector 101.

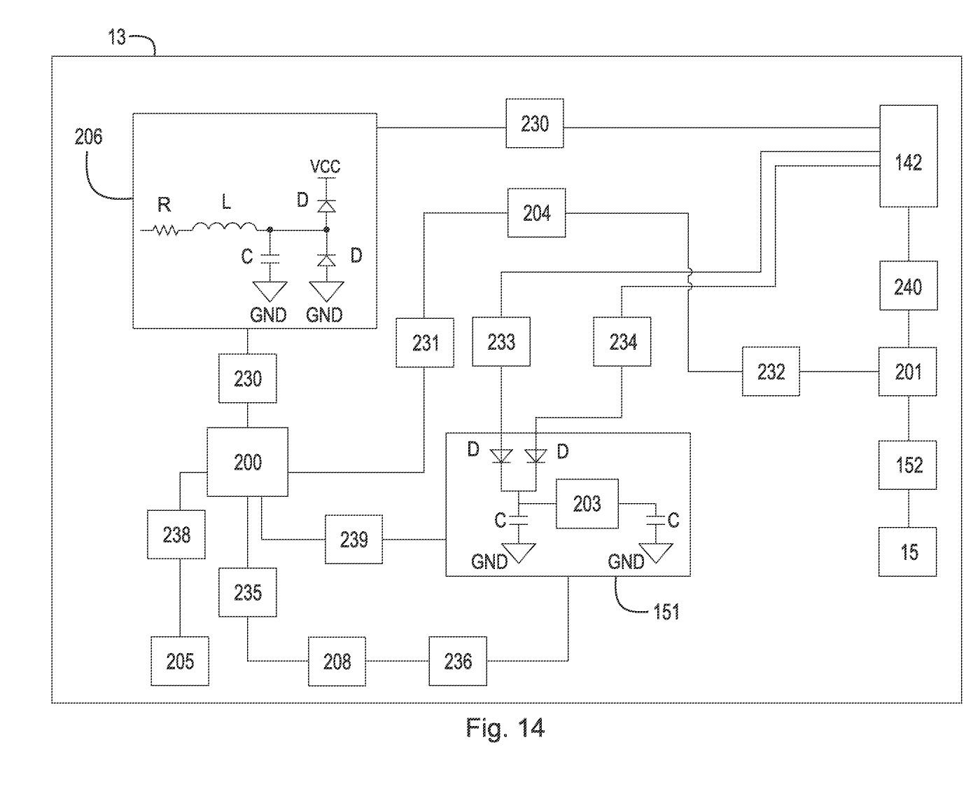

Translator unit 13 comprises television interface circuitry 150, power management circuitry 151, call circuit hardware 152, light control hardware 153, interface specific hardware 154 (hereinafter 20-pin connector 201), and translation integrated circuitry 155 (hereinafter microcontroller circuit 200). Translator unit 13 is connected to call station 15 via 20-pin connector 201 (shown in FIG. 14). Translator unit 13 is powered by a data line of television 11, for example, 5 mA at 5 VDC. However, translator unit 13 can be battery-powered.

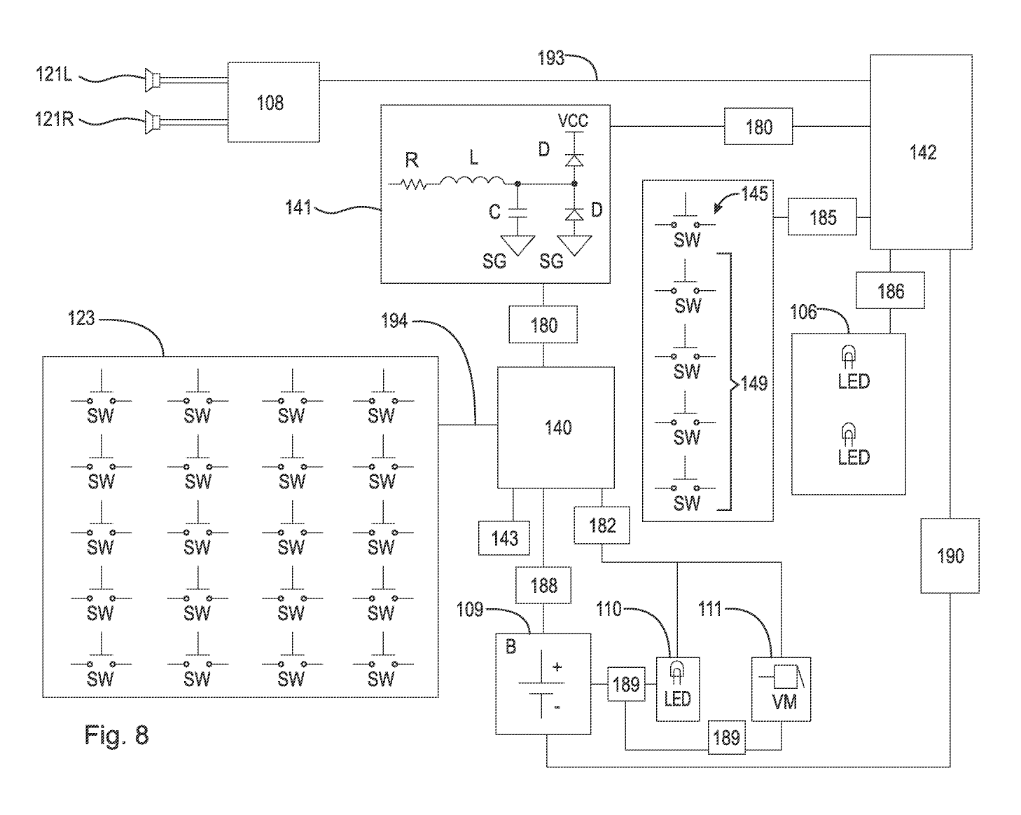

FIG. 8 is a block diagram view of pendant control 100. Pendant control 100 comprises plurality of buttons 125 (not shown), which allow patient 20 to control various functions, such as nurse call, room lights 12, television 11, and any other interactive controls for a particular application. Pendant control 100 can send and receive a plurality of electrical signals. Pendant control quick disconnect cable 101A and translator quick disconnect cable 101B are connected by quick disconnect connector 101 (shown in FIG. 4). Pendant control 100 interfaces with translator unit 13 through 24-pin connector 142. When a button is pressed on pendant control 100 that controls a television function, signal 194 from entertainment switches is sent to pendant control microcontroller IC1. After receiving signal 194, microcontroller IC1 sends synchronous data 180 to translator unit 13 (shown in FIG. 14) through 24-pin connector 142. All of the codes necessary to read synchronous data 180 sent from pendant control 100 to translator unit 13 (not shown) are stored within translator unit microcontroller IC2 (shown in FIG. 14). In another embodiment of the invention, synchronous data 180 to and from pendant control microcontroller IC1 pass through optional electrostatic discharge (ESD) suppression circuitry 141.

Translator unit microcontroller IC2 (shown in FIG. 14) is programmed to receive a plurality of signals from pendant control 100. After translator unit microcontroller IC2 (shown in FIG. 14) receives a signal, the signal is interpreted and sent to television 11 via television data output circuitry 204 (shown in FIG. 14).

It should be appreciated that microcontroller IC1 does not transmit a signal directly corresponding to the device it controls, but a generic signal for the function pressed. For example, if the channel up button has been pressed on pendant control 100, microcontroller IC1 will send the same signal for channel up to translator unit microcontroller IC2, irrespective of the device it controls. It should be further appreciated that translator unit microcontroller IC2 can be programmed to receive signals from microcontroller IC1 for any brand of television 11. It should also be appreciated that because television data output circuitry 204 is now located in translator unit 13, it does not have to be duplicated in each pendant control 100.

When a button is pressed on pendant control 100 that controls nurse call function 145, signal 185 bypasses pendant control microcontroller IC1 and translator unit microcontroller IC2 and is sent directly to call circuit hardware 152 (shown in FIG. 14). Similarly, when a button is pressed on pendant control 100 that controls an auxiliary function 149, signal 185 bypasses pendant control microcontroller IC1 and translator unit microcontroller IC2 and is sent directly to call circuit hardware 152 (shown in FIG. 14). Likewise, signal 186 for indicator light emitting diodes (LEDs) 106, to indicate whether a nurse call signal has been placed or acknowledged, is directly sent either from pendant control 100 to call circuit hardware 152 (shown in FIG. 14) or from call circuit hardware 152 (shown in FIG. 14) to pendant control 100.

In another embodiment of the invention, when a button is pressed on pendant control 100 that controls optional backlight 110, a signal from optional backlight switch (not shown) is sent to pendant control microcontroller IC1. After receiving a signal (not shown), microcontroller IC1 sends signal 182 to backlight 110. Similarly, when a button is pressed on pendant control 100 that controls optional vibration motor 111, a signal from optional vibration motor switch (not shown) is sent to pendant control microcontroller IC1. After receiving a signal (not shown), microcontroller IC1 sends signal 182 to vibration motor 111.

Headphone jack 108 includes a disconnect, which breaks the connection to speakers 121L and 121R when headphones are plugged in. Audio signals 193 from television or nurse call system pass from 24 pin-connector 142 to speakers 121L and 121R.

In another embodiment of the invention, pendant control 100 and translator unit 13 (shown in FIG. 14) are powered by optional battery 109. Optional battery 109 provides power 188 to microcontroller 140, power 189 to optional backlight 110, power 189 to optional vibration motor, and power 190 to translator unit 13 (shown in FIG. 14).

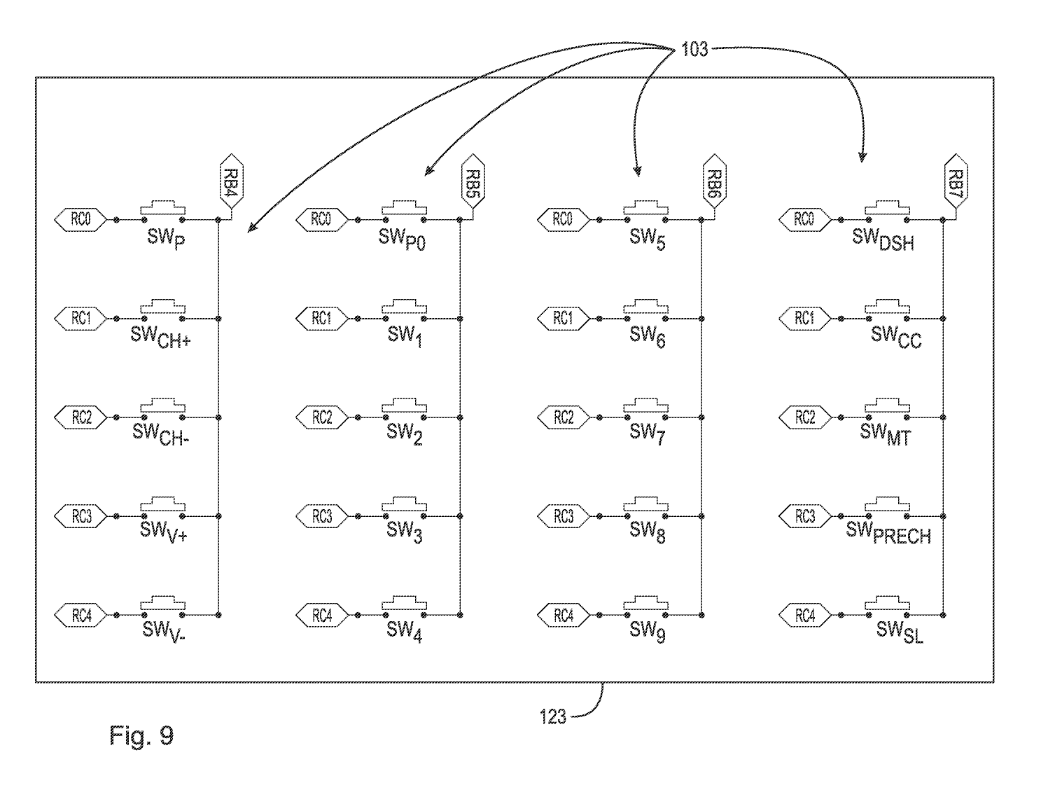

FIG. 9 is a schematic of entertainment control buttons 123 of pendant control 100 shown in FIG. 8. The entertainment portion of translator unit 13 includes a serial data interface for signaling between pendant control 100 and translator unit 13. Additionally, an output section allows coded signals to be sent to television 11 to control it based on commands from pendant control 100. Entertainment control buttons 123 comprise plurality of switches 103 including power switch SW_{P}, channel up switch SW_{CH+}, channel down switch SW_{CH-}, volume up switch SW_{V+}, volume down switch SW_{V-}, digit 0 switch SW₀, digit 1 switch SW₁, digit 2 switch SW₂, digit 3 switch SW₃, digit 4 switch SW₄, digit 5 switch SW₅, digit 6 switch SW₆, digit 7 switch SW₇, digit 8 switch SW₈, digit 9 switch SW₉, dash switch SW_{DSH}, closed captioning switch SW_{CC}, mute switch SW_{MT}, previous channel switch SW_{PRECH}, and sleep switch SW_{SL}. By way of an example, when a button is pressed on pendant control 100, a contact closure occurs in pendant control 100. A serial code is sent to translator unit 13. For example, channel up might send command 01 in hexadecimal while the digit 8 might send the command 12 in hexadecimal. It should be appreciated that coded signals may be sent and received using a serial interface, resistor comparator, keypad matrix or other technology that allows discernment of individual commands.

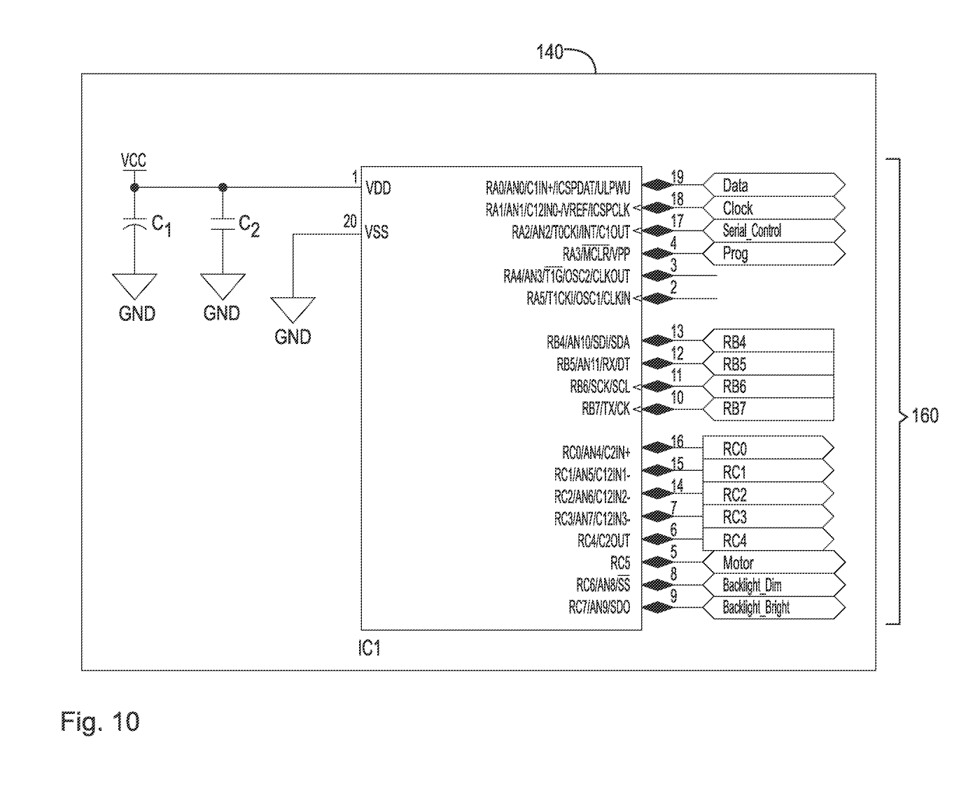

FIG. 10 is a schematic of microcontroller circuit IC1 shown in FIG. 8. Microcontroller circuit 140 comprises microcontroller IC1, plurality of pins 160, capacitor C₁, and polarized capacitor C₂. In a preferred embodiment, microcontroller IC1 is manufactured by Microchip Model Pic16F687-I/P. Microcontroller IC1 regulates commands between pendant control 100 and an entertainment device, for example, television 11. The microcontroller code can be generalized for standard applications, or customized for unique entertainment systems or situations. Microcontroller IC1 also includes nonvolatile memory that allows programmed settings (such as television control code set, behavior of locator light and backlight, etc.) to be retained even in the event of prolonged power loss.

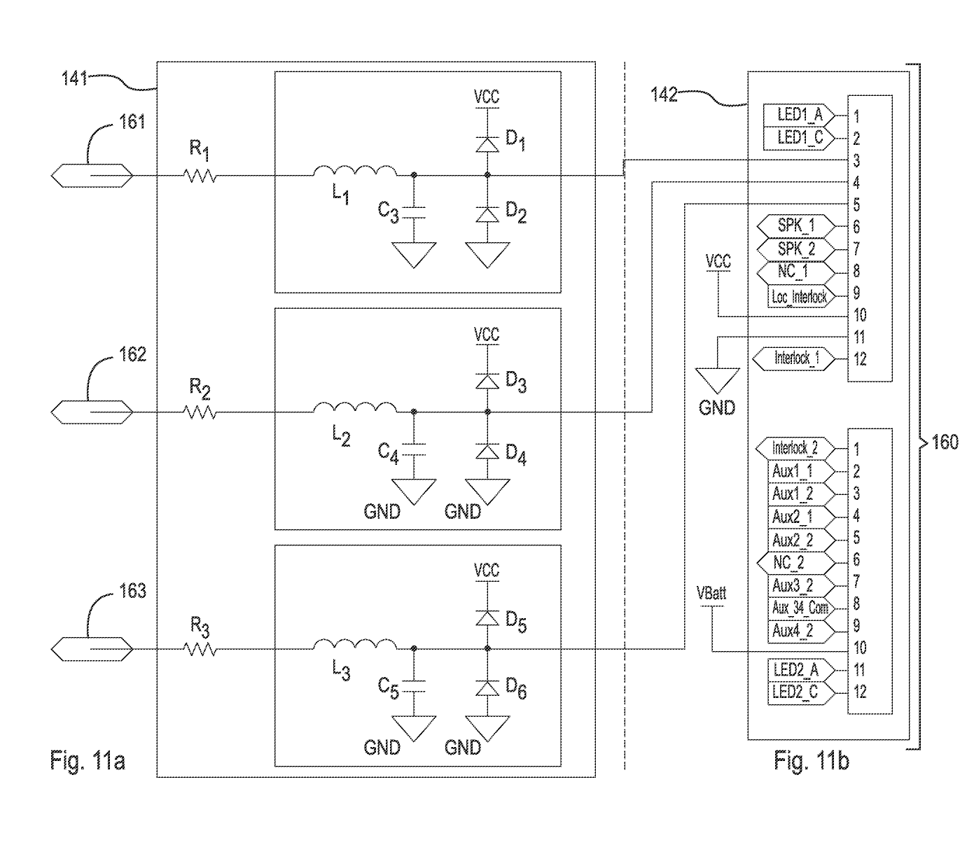

A schematic of optional electrostatic discharge (ESD) suppression unit 141 also shown in FIG. 8 is shown in FIG. 11A. ESD suppression unit 141 comprises ESD suppression for data function 161, clock function 162, and serial control function 163. ESD suppression for data function 161 comprises diode D₁, diode D₂, capacitor C₃, inductor L₁, and resistor R₁. ESD suppression for clock function 162 comprises diode D₃, diode D₄, capacitor C₄, inductor L₂, and resistor R₂. ESD suppression for serial control function 163 comprises diode D₅, diode D₆, capacitor C₅, inductor L₃, and resistor R₃. If an inductor is not used for data function 161, clock function 162, or serial control function 163, then the respective inductors should be replaced with 0 Ohms.

FIG. 11B is a schematic of 24-pin connector 142 shown in FIG. 8. 24-pin connector 142 contains plurality of pins 160. In an example embodiment, 24-pin connector 142 uses commercially available spring-loaded contacts (similar to pogo-pins) on the translator side and simple pads on a printed circuit board for pendant control 100 and programmer 300 (described in further detail below). Optional ESD suppression unit 141 (shown in FIG. 11A) is connected to 24-pin connector 142.

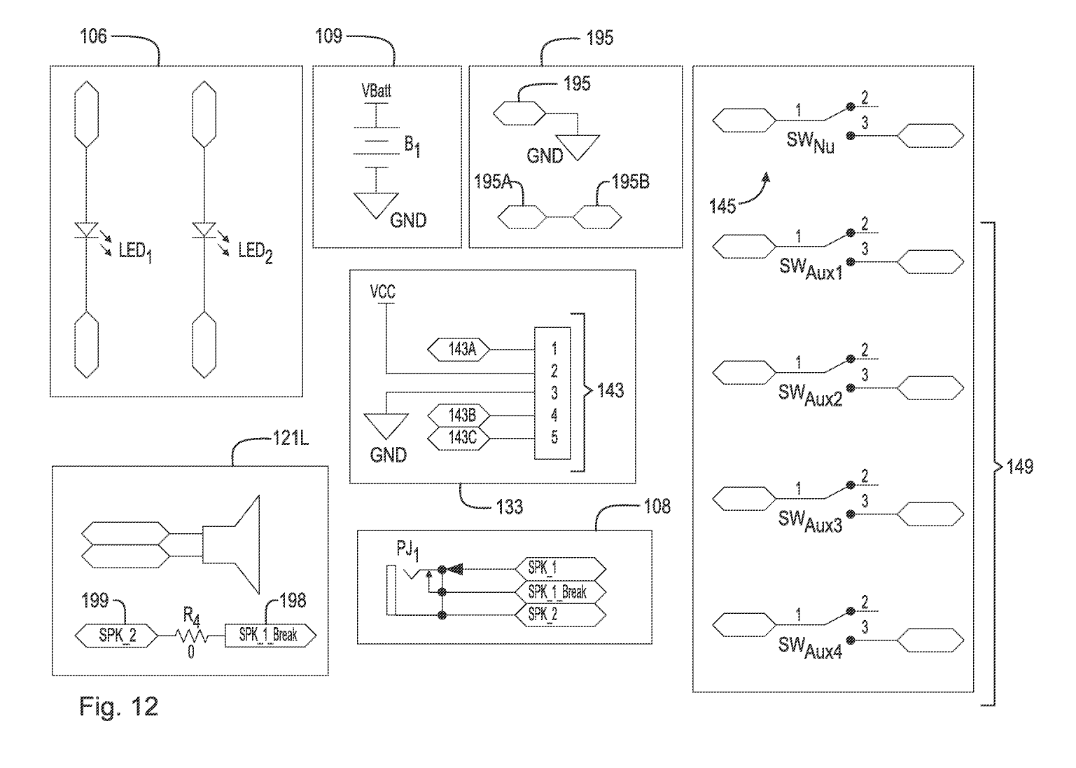

A schematic of left speaker 121L, nurse call function 145, auxiliary functions 149, programming connector 133, local_interlock 195, optional indicator light emitting diodes (LEDs) 106, headphone jack 108, and optional battery 109 (as shown in FIG. 8) is shown in FIG. 12. Speaker 121L comprises resistor R₄, line 1 speaker break 198 and line 2 speaker 199. Although not shown, pendant control 100 includes a right speaker 121R, which structurally and electrically identical to left speaker 121L. Nurse call function 145 contains single pole, double throw (SPDT) switch SW_{Nu}. Auxiliary functions 149 comprise plurality of SPDT switches including auxiliary switch SW_{AUX1}, auxiliary switch SW_{AUX2}, auxiliary switch SW_{AUX3}, and auxiliary switch SW_{AUX4}. Programming connector 133 comprises 5-pin connector 143. 5-pin connector 143 comprises program function 143A, data function 143B, and clock function 143C. Local_interlock 195 comprises local_interlock pins 195A and 195B. Local_interlock pin 195A is located among pins 1-12 of 24-pin connector 142 and local_interlock 195B is located among pins 12-24 of 24-pin connector 142. If pendant control 100 is plugged into or disconnected from translator unit 13, a signal is sent to translator unit 13. Optional call light emitting diodes 106 comprise light emitting diodes LED₁ and LED₂. In an example embodiment, optional battery 109 is powered by two double AA batteries.

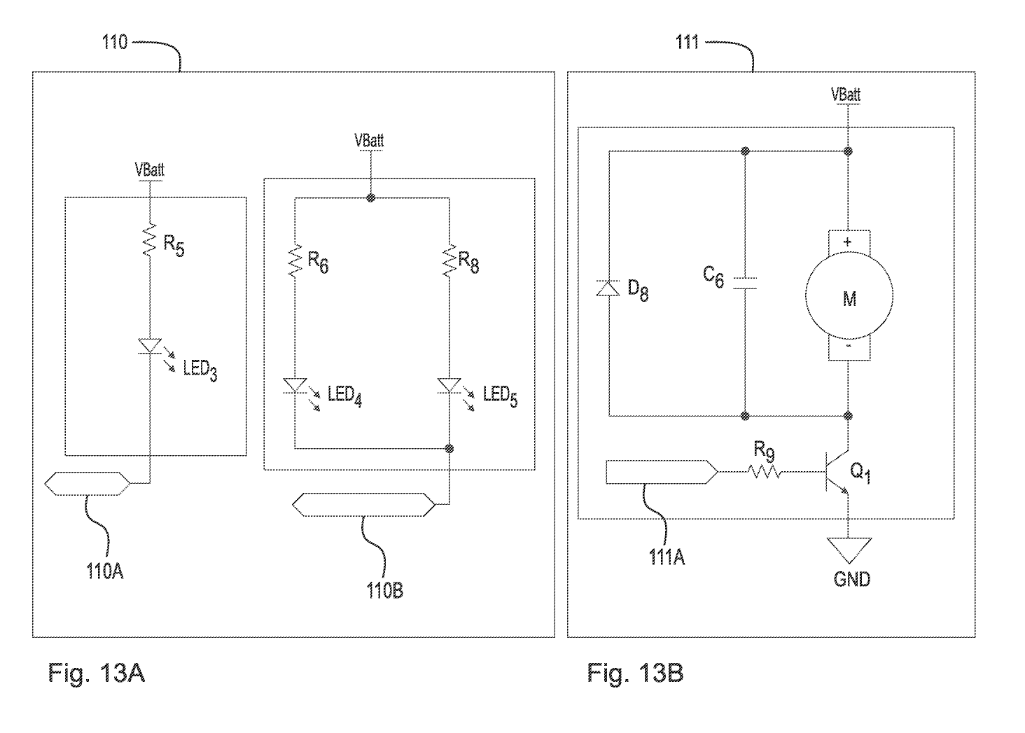

FIG. 13A is a schematic of optional backlight light emitting diodes (LEDs).

Optional feature backlight 110 comprises backlight dim connector 110A and backlight bright connector 110B. Backlight dim connector 110A comprises resistor R₅ and indicator LED₃. Backlight bright connector 110B comprises resistors R₆ and R₈ and indicators LED₄ and LED₅.

FIG. 13B is a schematic of optional vibration feedback motor circuitry. Optional vibration feedback motor circuitry 111 comprises motor connector 111A, electric motor M, diode D₈, capacitor C₆, resistor R₉, and transistor Q₁.

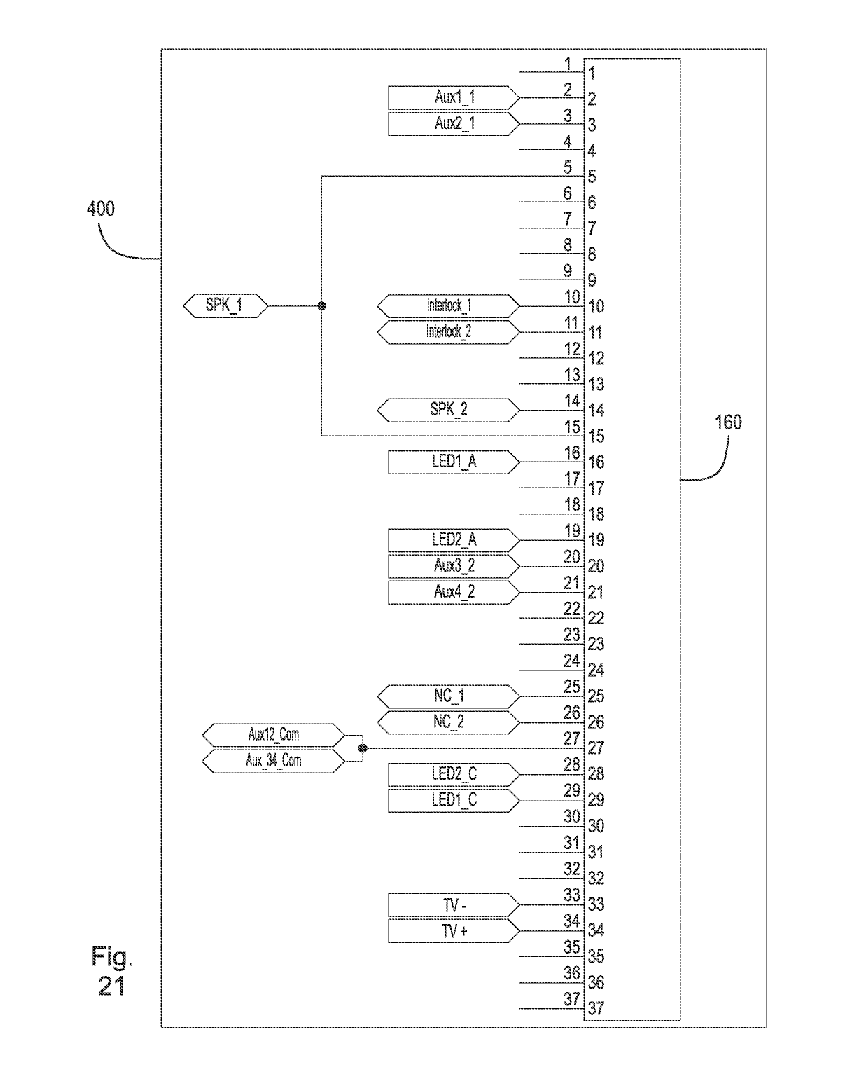

FIG. 14 is a block diagram of the electrical circuit of translator unit 13. Translator unit 13 sends and receives a plurality of signals by pendant control 100 and call station 15. Translator unit 13 and pendant control 100 are connected by quick disconnect connector 101 (shown in FIG. 4). On one end of quick disconnect connector 101 is pendant control quick disconnect cable 101A and on the other end of quick disconnect connector 100 is translator unit quick disconnect cable 101B (shown in FIG. 4). 24-pin connector 142 interfaces with pendant control 100 or programming connector 133. Translator unit 13 comprises call circuit hardware 152. Translator unit 13 and call circuit hardware 152 are connected by 20-pin connector 201. Call circuit hardware 152 sends and receives signals by pendant control 100 and call station 15. When a button is pressed on pendant control 100 for nurse call 145 or auxiliary function 149, a signal is sent via 24-pin connector 142 to 20-pin connector 201. 20-pin connector 201 interfaces with call station 15 via 37-pin connector 400 (shown in FIG. 21). Call station 15 is wired to the various electronic devices in the room, including television 11, lighting 12, and nurses' station (not shown).

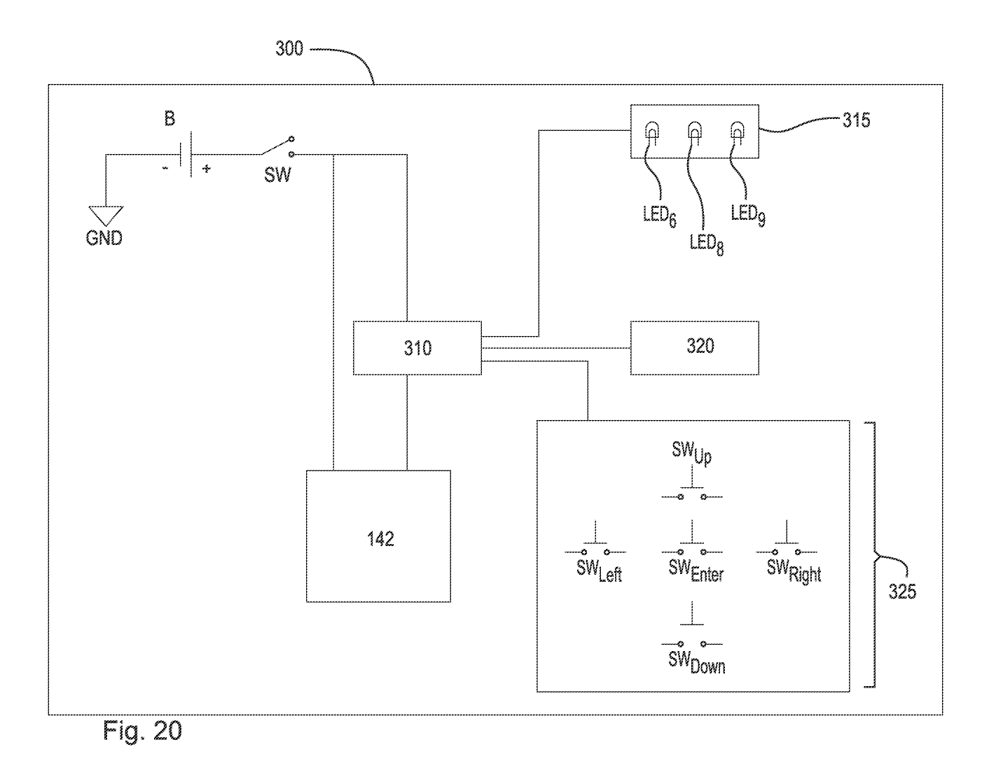

Microcontroller IC2 of translator unit 13 sends and receives serial data 230 by pendant control 100 or programming connector 133. Microcontroller IC2 is programmable by translator unit programmer 300 (shown in FIG. 20). Translator unit programmer 300 (shown in FIG. 20) interfaces with microcontroller IC2 via programming connector 133. Microcontroller sends and receives serial data 238 by programming connector 233. In another embodiment of the invention, microcontroller IC2 receives light or dark signals 235 from optional ambient light sensor 208. In yet another embodiment of the invention, serial data 230 sent and received by microcontroller IC2 by pendant control 100 or programming connector 133 passes through optional electrostatic discharge (ESD) suppression unit 206.

Microcontroller IC2 sends and receives a plurality of serial data 230 by pendant control 100 and programming connector 133. When an entertainment button 123 is pushed on pendant control 100 a signal 194 is generated to microcontroller IC1. Signal 194 from microcontroller IC1 is sent by 24-pin connector 142 to microcontroller IC2. After translator unit microcontroller IC2 receives a signal, signal for television control 231 is sent to television data output circuitry 204. From television data output circuitry 204, the signal is sent to television 11 via television data line 232.

It should be appreciated that translator unit microcontroller IC2 can be programmed to receive signals from pendant control microcontroller IC1 for any brand of television 11. It should also be appreciated that because television data output circuitry 204 is now located in translator unit 13, it does not have to be duplicated in each pendant control 100.

Translator unit 13 also comprises power management circuitry 151, which receives power from television data line 233. Power is sent to optional ambient light level sensor 208 via power line 236, to microcontroller IC2 via power line 239, and to pendant control 100 via 24-pin connector 142. In another embodiment of the invention, power management circuitry 151 receives power from pendant control optional batteries 234. Power management circuitry 151 interfaces with pendant control 100 by 24-pin connector 142 to give a constant level of power to pendant control 100. Power management circuitry 151 adjusts the polarity and manages the voltage levels of pendant control 100 when signals are sent, regardless of the voltage level provided by television 11 or batteries. Low drop out voltage regulator 203 enables pendant control 100 to maintain a consistent power level, namely 3 volts, necessary for pendant control 100 to operate all functions in the room. Different television brands provide different levels of power output and polarities. It should be appreciated that power management circuitry 151 enables pendant control 100 to maintain the same power level necessary for all functions to work, despite the power output of any electrical device. Protection and isolation between the two potential power sources is provided in case both are present simultaneously.

Translator unit 13 further comprises call circuit hardware 152. Call circuit hardware 152 sends and receives signals by pendant control 100 and call station 15. When a button is pressed on the pendant control 100 for nurse call 145 or auxiliary function 149, a signal is sent via 24-pin connector 142 to 20-pin connector 201. 20-pin connector 201 is wired to call circuit hardware 152. Translator unit 13 interfaces with call station 15 via 37-pin connector 400 (shown in FIG. 21). It should be appreciated that call circuit hardware can send signals to any brand or manufacturer of call station 15.

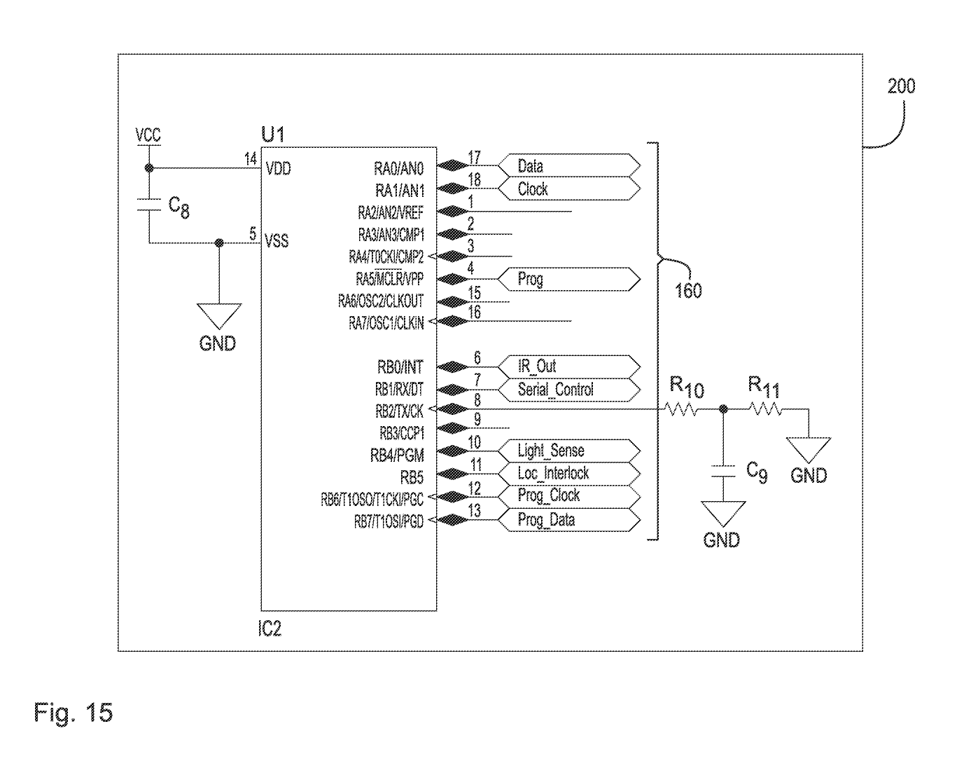

FIG. 15 is a schematic of microcontroller circuit 200 shown in FIG. 14. Microcontroller circuit 200 comprises microcontroller IC2, plurality of pins 160, capacitor C₈, capacitor C₉, resistor R₁₀, and resistor R₁₁. In an example embodiment, microcontroller IC2 is manufactured by Microchip Model PIC16(L)F1826/27.

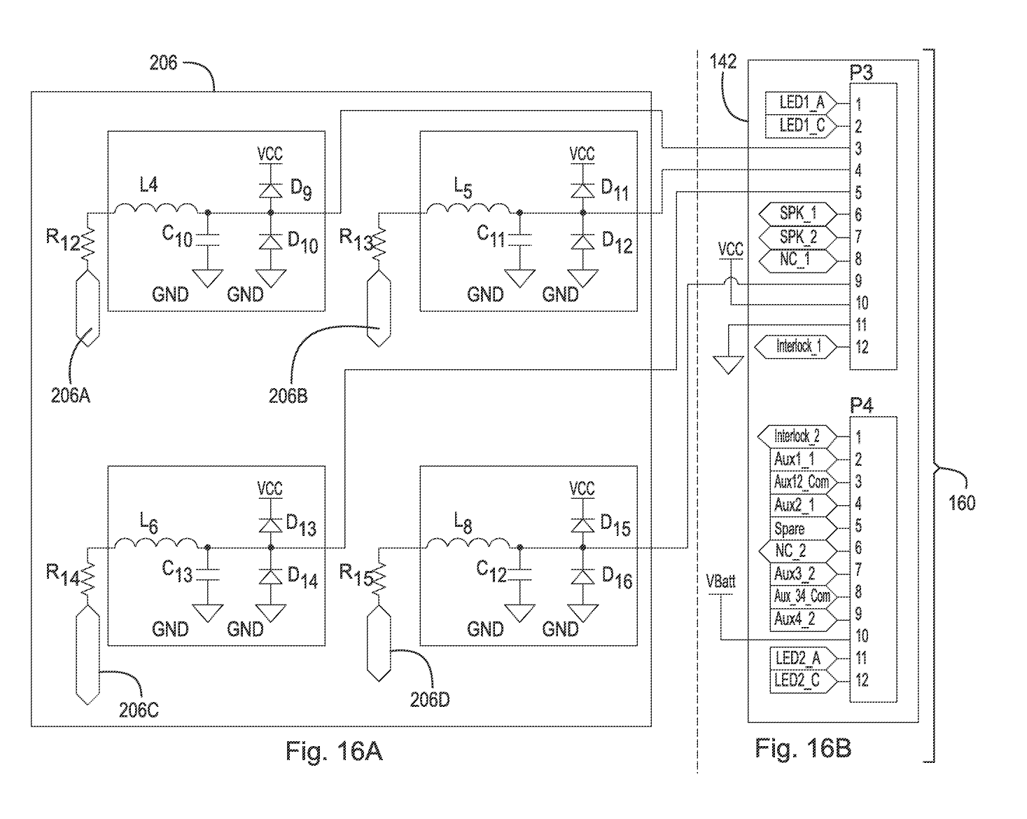

FIG. 16A is a schematic of optional electrostatic discharge (ESD) suppression 206 shown in FIG. 14. Optional ESD suppression unit 206 contains ESD suppression for data function 206A, clock function 206B, serial control function 206C, and Local_Interlock function 206D. ESD suppression for data function 206A includes diode D₉, diode D₁₀, capacitor C₁₀, inductor L₄, and resistor R₁₂. ESD suppression for clock function 206B includes diode D₁₁, diode D₁₂, capacitor C₁₁, inductor L₅, and resistor R₁₃. ESD suppression for serial control function 206C includes diode D₁₃, diode D₁₄, capacitor C₁₃, inductor L₆, and resistor R₁₄. ESD suppression Local_Interlock function 206D includes diode D₁₅, diode D₁₆, capacitor C₁₂, inductor L₈, and resistor R₁₅. If an inductor is not used for data function 206A, clock function 206B, serial control function 206C, or Local_Interlock function 206D, then the respective inductors should be replaced with O Ohms.

FIG. 16B is a schematic of the 24-connector shown in FIG. 14. 24-pin connector 142 comprises a plurality of pins 160. Optional ESD suppression unit 206 shown in FIG. 15a is connected to 24-pin connector 142.

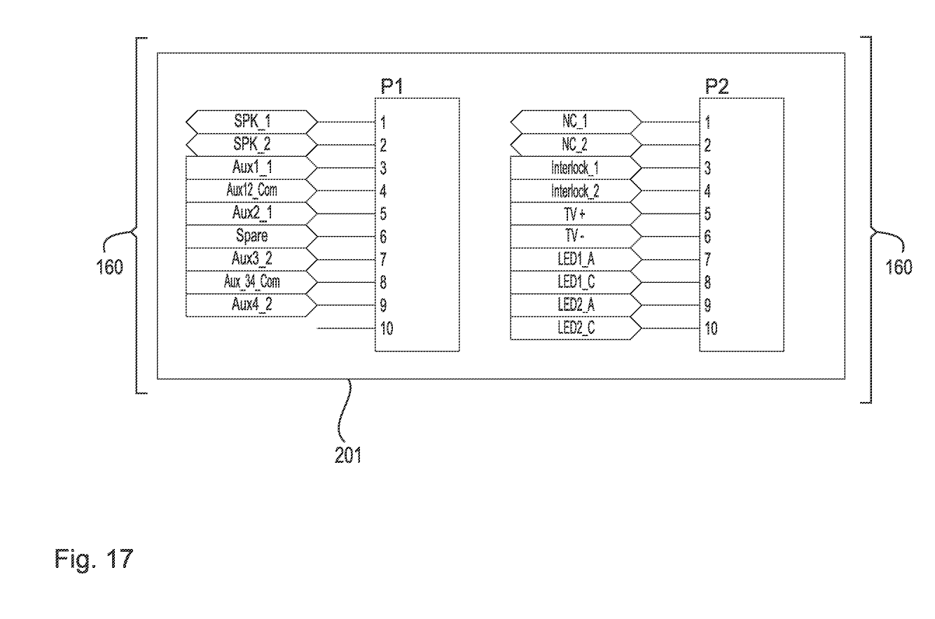

FIG. 17 is a schematic of 20-pin connector 201 shown in FIG. 14. 20-pin connector 201 comprises a plurality of pins 160. 20-pin connector 201 interfaces with 37-pin connector 400 (shown in FIG. 21). In an example embodiment, 20-pin connector 201 is a simple pair of pins and sockets that allow one printed circuit board assembly to be stacked over another internal to translator unit 13. This design allows easy access, if necessary. 20-pin connector 201 further comprises local_interlock pins 195A and 195B. If any of the wiring for nurse call function 145 is compromised, a signal (not shown) is sent to translator unit 13.

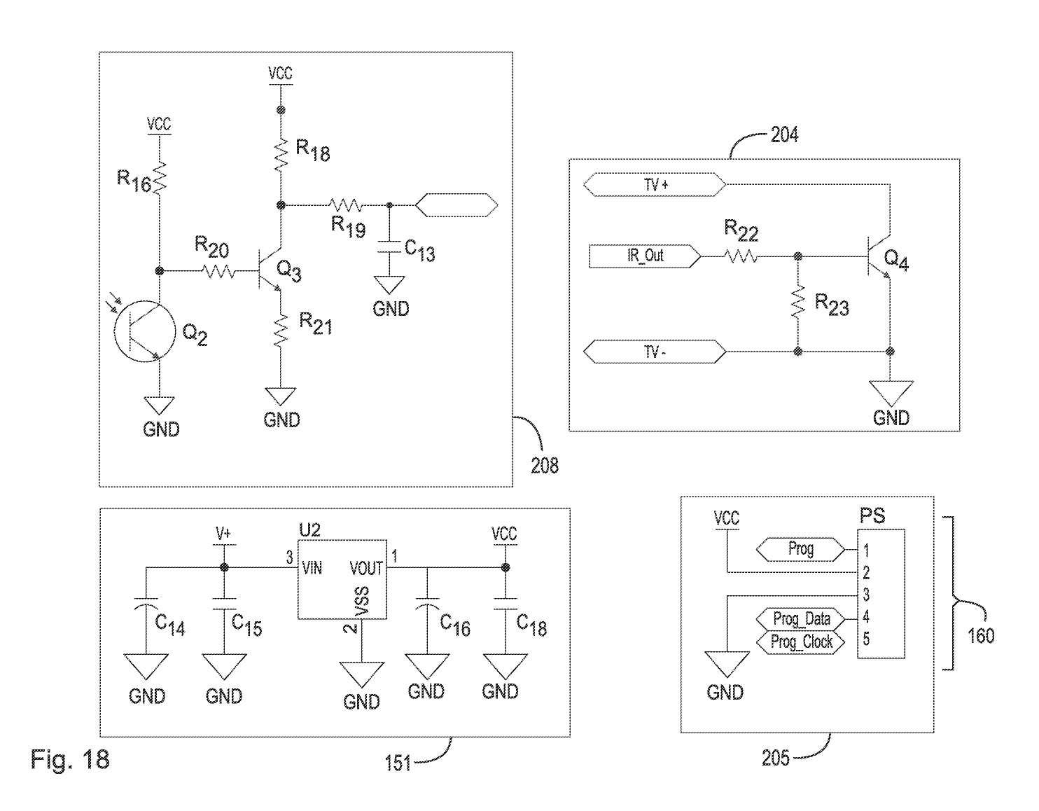

FIG. 18 is a schematic of power management circuitry 151, television data output circuitry 204, programming connector 205, and optional ambient light level sensor 208 shown in FIG. 14. Optional ambient light level sensor 208 comprises resistor R₁₆, resistor R₁₈, resistor R₁₉, resistor R₂₀, resistor R₂₁, capacitor C₁₃, phototransistor Q₂, and NPN bipolar transistor Q₃. Power management circuitry 151 comprises polarized capacitor C₁₄, capacitor C₁₅, polarized capacitor C₁₆, and polarized capacitor C₁₈. Television data output circuitry 204 comprises plurality of pins 160, resistor R₂₂, resistor R₂₃, and NPN bipolar transistor Q₄. Programming connector 205 comprises a plurality of pins 160.

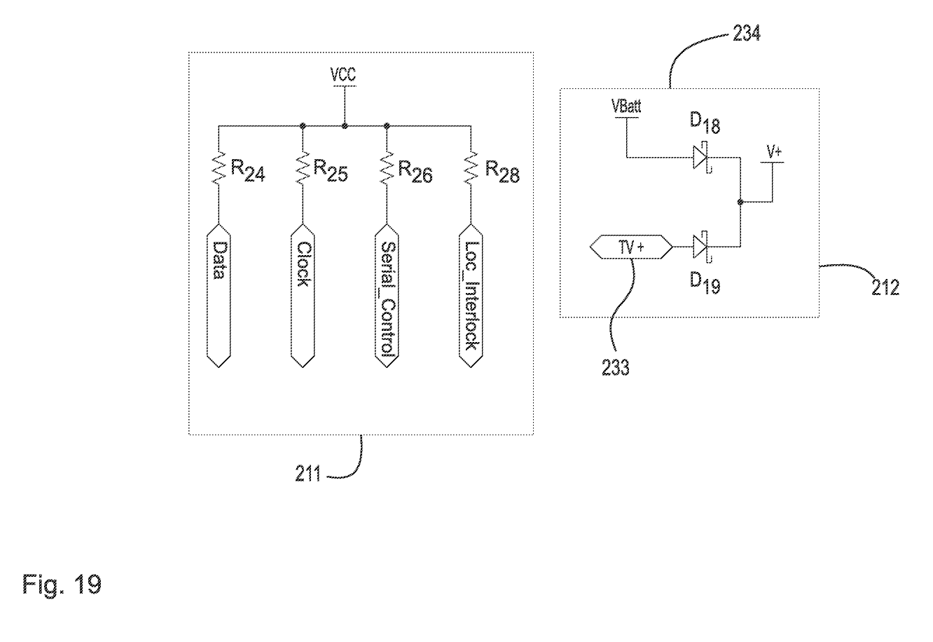

FIG. 19 is a schematic of serial control pull-ups 211 and power input 212 (television or optional batteries) shown in FIG. 14. Serial control pull-ups 211 comprise plurality of pins 160, resistor R₂₄, resistor R₂₅, resistor R₂₆, and resistor R₂₈. Power input 212 derives from television 213 or optional batteries 214 located in pendant control 100. Power input 212 from television 213 includes Schottky diode D₁₈. Power input 212 from battery 214 includes Schottky diode D₁₉.

FIG. 20 is a block diagram of the electrical circuit of translator programmer unit 300. Programmer unit 300 interfaces with translator unit 13 via 24-pin connector 142. Programmer unit comprises microcontroller circuitry 310. Microcontroller circuitry 310 comprises microcontroller IC3 (not shown) with EEPROM to store settings, which are used to program translator unit 13. Programming unit 300 further comprises power switch SW_{P}, battery power source B, status indicator LEDs 315, LCD display 320, and user input switches 325. Status indicators 315 further comprise light emitting diodes LED₆, LED₈, and LED₉, which correspond to success indicator, fail indicator, and working indicator, respectively. User input switches 320 further comprise SW_{Up}, SW_{Down}, SW_{Left}, SW_{Right}, SW_{Enter}. It should be appreciated that programmer unit 300 is not necessary for the operation of pendant control 100. However, programmer unit 300 is necessary for initial configuration and to make any necessary changes to the behavior of translator unit 13.

It should be appreciated that the communication between translator unit 13 and pendant control 100 or translator unit 13 and programmer 300 is via a synchronous serial data stream. One wire is used as a clock to provide a pulse each time a bit is ready to be read, and a data line is used to send the individual bits.

FIG. 21 is a schematic of 37-pin wall interface connector 400. 37-pin connector 400 comprises a plurality of pins 160. Translator unit 13 interfaces with call station 15 via 37-pin connector 400.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### REFERENCE NUMERALS

10 pendant control
11 television
12 lights
13 translator unit
14 bed
15 call station
20 patient
21 speaker
22 plurality of speaker perforations
23 plurality of buttons
30 housing
31 housing portion
32 housing portion
40 plurality of electrical components
41 switches
42 interface integrated circuit
43 power management circuitry
44 television interface
46 call circuit hardware
48 light control hardware
49 interface specific hardware
50 first circuit board
51 second circuit board
100 pendant control
101 quick disconnect connector
101A quick disconnect cable
101B quick disconnect cable
103 plurality of switches
104 interface integrated circuit
106 optional call indicator light emitting diodes (LEDs)
108 headphone jack
109 optional battery
110 optional backlight
110A backlight dim
110B backlight bright
111 optional vibration feedback motor circuitry
111A motor connector
112 optional finder
121L left speaker
121R right speaker
123 plurality of entertainment buttons
125 plurality of buttons
126 plurality of electrical components
130 housing
131 housing portion
132 housing portion
133 programming connector
140 microcontroller
141 optional electrostatic discharge (ESD) suppression
142 24-pin connector
143 5-pin connector
143A program function
143B data function
143C clock function
145 nurse call function
149 auxiliary functions
150 television interface circuitry
151 power management circuitry
152 call circuit hardware
153 light circuit hardware
154 interface specific hardware
155 translation integrated circuitry
160 plurality of pins
161 data function
162 clock function
163 serial control function
180 synchronous data (bi-directional) to/from translator unit
182 control line
185 nurse call and auxiliary function signal pass through line
186 indicator LED signal pass through line
188 power line
189 power line
192 optional vibration motor power line
193 audio signal from television or nurse call system
194 signal from entertainment switches to microcontroller
195 Local_Interlock
195A Interlock_{—}1 pin
195B Interlock_{—}2 pin
198 line 1 speaker break
199 line 2 speaker
200 microcontroller
201 20-pin connector
203 voltage regulator
204 television data output circuitry
205 programming connector
206 optional electrostatic discharge (ESD) suppression unit
206A data function
206B clock function
206C serial control function
206D Loc_Interlock function
208 optional ambient light level sensor
211 serial control pull-ups
212 power input
230 serial data to/from pendant or programmer
231 data signal for television control
232 output to television data line
233 power from television data line
234 optional pendant control battery power
235 light/dark signal
236 power line
238 serial data to/from programming connector
239 power to microcontroller
240 nurse call, auxiliaries, and audio signals
300 translator unit programmer
310 microcontroller circuitry
315 status indicator LEDs
320 LCD display
325 user input switches
400 37-pin connector
500 screws

1-34. (canceled)

35. A communication system for a health care facility, comprising:
a translator unit operatively arranged to communicate electronically with a device to be controlled; and,
a pendant control located spatially separate and remote from said translator unit, said pendant control operatively arranged to communicate electronically with said translator unit.

36. The communication system recited in claim 35, wherein said translator unit is programmable.

37. The communication system recited in claim 35, wherein said pendant control includes a speaker operatively arranged to transmit sound produced by said device to be controlled.

38. The communication system recited in claim 37, wherein said speaker is operatively arranged to function both as a speaker and as a microphone.

39. The communication system recited in claim 35, wherein said pendant control comprises a plurality of electrical switches.

40. The communication system recited in claim 39, wherein at least one of said plurality of electrical switches is operatively arranged to control a channel of a television.

41. The communication system recited in claim 39, wherein at least one of said plurality of electrical switches is operatively arranged to control volume of a television.

42. The communication system recited in claim 35, wherein said translator unit is operatively arranged to interpret a plurality of signals sent to and from said pendant control.

43. The communication system recited in claim 35, wherein said translator unit is operatively arranged to interpret a plurality of signals sent to and from a call station.

44. The communication system recited in claim 35, wherein said translator unit is operatively arranged to send a plurality of signals from said pendant control to a call station.

45. The communication system recited in claim 35, wherein said translator unit is operatively arranged to send a plurality of signals from a call station to said pendant control.

46. The communication system recited in claim 35, wherein said device to be controlled is a television.

47. The communication system recited in claim 35, wherein said device to be controlled is a nurses' station.

48. The communication system recited in claim 35, wherein said device to be controlled is an electric light.

49. A translator unit for communicating with a device to be controlled, comprising:
a housing electrically connected to a call station;
interface specific hardware electrically connected to a pendant control; and,
a translation integrated circuit operatively arranged to communicate with said pendant control and said device to be controlled.

50. The translator unit recited in claim 49, wherein said housing is located spatially separate and remote from said pendant control.

51. The translator unit recited in claim 49, wherein said interface specific hardware is a 24-pin connector.

52. The translator unit recited in claim 51, wherein said 24-pin connector is electrically connected to said pendant control.

53. The translator unit recited in claim 49, wherein said translation integrated circuit is a microcontroller.

54. The translator unit recited in claim 53, wherein said microcontroller is programmable.

55. The translator unit recited in claim 53, wherein said microcontroller is operatively arranged to interpret a plurality of signals sent from a call station.

56. The translator unit recited in claim 53, wherein said microcontroller is operatively arranged to interpret a plurality of signals sent from a pendant control.

57. The translator unit recited in claim 49, wherein said translator unit further comprises a quick disconnect cable, operatively arranged to disconnect and reconnect a pendant control.

58. The translator unit recited in claim 49, wherein said translator unit further comprises a television interface, said television interface operatively arranged to send a plurality of signals from the translator unit to a television.

59. The translator unit recited in claim 49, wherein said translator unit further comprises a power management circuit, said power management circuit operatively arranged to provide a consistent power level to said pendant control.

60. The translator unit recited in claim 49, wherein said translator unit further comprises a call circuit hardware, said call circuit hardware operatively arranged to send and receive a plurality of signals to and from said call station, said call station electrically connected to a nurses' station.

61. The translator unit recited in claim 49, wherein said translator unit further comprises a light control hardware, said light control hardware operatively arranged to send a plurality of signals to said call station, said call station electrically connected to lighting fixtures.

62. A pendant control for communicating with a translator unit, consisting of:
a housing connected to said translator unit, said housing located spatially separate and remote from said translator unit;
a plurality of electrical switches operatively arranged to control an electrical device; and,
an interface integrated circuit operatively arranged to send and receive a plurality of signals from said translator unit.

63. The pendant control recited in claim 62, wherein said housing is electrically connected to said translator unit.

64. The pendant control recited in claim 62, wherein said housing is connected to said translator unit via a quick disconnect connector.

65. The pendant control recited in claim 62, wherein said housing is powered by said translator unit.

66. The pendant control recited in claim 62, wherein at least one of said plurality of electrical switches are operatively arranged to control channels of a television.

67. The pendant control recited in claim 66, wherein at least one of said plurality of electrical switches is operably arranged to control volume of said television.

68. The pendant control recited in claim 62, wherein at least one of said plurality of electrical switches is operatively arranged to control lighting in a room.

69. The pendant control recited in claim 62, wherein at least one of said plurality of electrical switches is operatively arranged to control communication with a nurses' station.
